(19) United States
(12) Patent Application Publication
(10) Pub. No.: US 2018/0275617 A1
(43) Pub. Date: Sep. 27, 2018

(54) ELECTRONIC TIMEPIECE

(71) Applicant: Seiko Epson Corporation, Tokyo (JP)

(72) Inventor: Saori HASHIZUME, Shimosuwa (JP)

(21) Appl. No.: 15/914,518

(22) Filed: Mar. 7, 2018

(30) Foreign Application Priority Data
Mar. 21, 2017 (JP) 2017-054377

(51) Int. Cl. G04G 17/04; G04G 19/00; G04R 60/12; G04G 17/06

(52) U.S. Cl. CPC G04G 17/04; G04G 19/00; G04R 20/02; G04G 17/06; G04R 60/12

(57) ABSTRACT

The electronic timepiece has an optically transparent dial; a solar battery disposed relative to the dial in the direction in which the external light is emitted, and having a photovoltaic solar cell; an antenna disposed relative to the dial in the direction in which the external light is emitted, and receiving radio signals; and an outside case configured to house the dial, the solar battery, and the antenna. A through-hole is disposed in the solar battery; the antenna has an overlap with the through-hole when seen in plan view from a direction perpendicular to the dial; the solar battery has a flange protruding to the outside case side in plan view; and the flange is disposed so that in plan view the through-hole is located on the inside side of the outside case from the flange.

### BACKGROUND

### 1. Technical Field

The present invention relates to an electronic timepiece.

### 2. Related Art

Electronic timepieces having a patch antenna or other type of antenna for receiving radio signals such as signals transmitted from positioning information satellites, and a solar battery, are known from the literature. So that light can pass to the solar battery, such electronic timepieces typically have an optically transparent dial. The solar battery is disposed on the back cover side of the dial, and the antenna is disposed on the back cover side of the solar battery.

To prevent shielding of radio signals by the solar battery disposed above the antenna, the technology described in JP-A-2010-96707 provides a notch, or opening, in the solar battery in the area around the antenna.

When a notch is provided as described in JP-A-2010-96707, the shape of the solar battery in plan view is formed with a roughly U-shaped configuration forming the notch. The parts of the solar battery on opposing sides of the notch generally come to a point at the outside circumference ends, and are easily deformed or bent. A problem with solar batteries formed with such a notch is that because the outside circumference part is easily deformed, the batteries are difficult to handle when assembling the electronic timepiece.

### SUMMARY

An objective of the present invention is to provide an electronic timepiece wherein deformation of the solar battery is suppressed by also suppressing shielding of radio frequency signals by a solar battery disposed above the antenna.

To achieve the foregoing objective, an electronic timepiece according to a preferred aspect of the invention has an optically transparent dial having one surface to which external light is incident, and another surface from which the external light is emitted; a solar battery disposed relative to the dial in the direction in which the external light is emitted, and having a photovoltaic solar cell; an antenna disposed relative to the dial in the direction in which the external light is emitted, and receiving radio signals; and an outside case configured to house the dial, the solar battery, and the antenna. A through-hole is disposed in the solar battery; the antenna has an overlap with the through-hole when seen in plan view from a direction perpendicular to the dial; the solar battery has a flange protruding to the outside case side in plan view; and the flange is disposed so that in plan view the through-hole is located on the inside side of the outside case from the flange.

Because the antenna is disposed overlapping the through-hole in the solar battery in plan view, this configuration can suppress shielding of radio signals resulting from the antenna being superimposed with a solar cell. By providing a through-hole as the part of the solar battery where a solar cell is not present, the outside circumference part of the solar battery is more resistant to deformation, and the solar battery is easier to handle when assembling the electronic timepiece, than with a configuration in which a notch is formed from the outside circumference as the part of the solar battery where a solar cell is not present. By forming the through-hole on the inside side of the outside case from the flange of the solar battery in plan view, this configuration can increase the width from the edge of the outside circumference part of the solar battery to the edge of the through-hole, when compared with a configuration having a through-hole formed without providing a flange. As a result, the strength of the part of the solar battery on the outside circumference side of the through-hole can be increased.

An electronic timepiece according to another aspect of the invention preferably also has a first member disposed positioned with the solar battery; and the flange has a positioning part configured to position the solar battery to the first member.

This configuration enables using the flange as a positioning member.

An electronic timepiece according to another aspect of the invention preferably also has a circuit board connected to the solar battery; and the flange has a connection terminal connected to a wiring member that connects the solar battery to the circuit board.

This configuration enables also using the flange as a connection member to a wiring member.

An electronic timepiece according to another aspect of the invention also preferably has a solar cell disposed to the flange.

By providing a solar cell on the flange, this configuration enables increasing the power generating capacity.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is an overview of a GPS system including an electronic timepiece according to the invention.

FIG. 2 is a plan view of the electronic timepiece from the face side.

FIG. 3 is a basic section view of the electronic timepiece.

FIG. 4 is a block diagram of the electronic control system of the electronic timepiece.

FIG. 5 is a plan view of the solar battery from the face side.

FIG. 6 is a plan view of the dial bridge ring from the face side.

FIG. 7 is a plan view of the main plate from the face side.

FIG. 8 is an oblique view of the solar battery and circuit board when connected.

FIG. 9 is a plan view of the solar battery in another embodiment of the invention.

### DESCRIPTION OF EMBODIMENTS

Preferred embodiments of the present invention are described below with reference to the accompanying figures. Note that the scale and size of members and parts shown in the figures referenced below may differ from the actual scale and size for convenience of description and illustration. The following embodiments include various technically desirable limitations while describing preferred embodiments of the invention, but the scope of the invention is not limited to the following unless such limitation is expressly stated.

A: Summary of the Electronic Timepiece

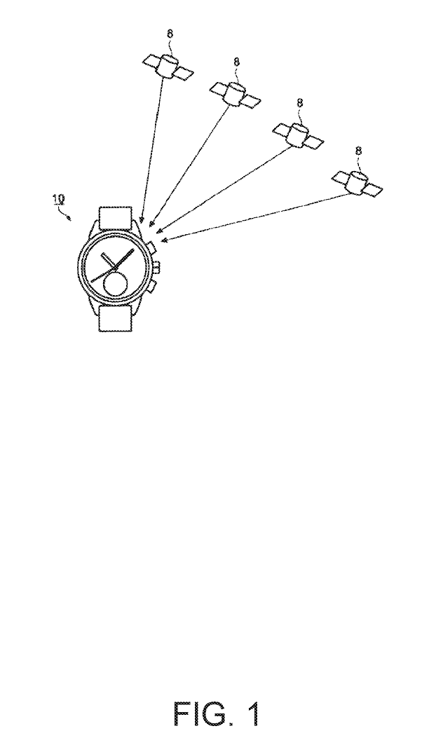

A preferred embodiment of the invention is described next with reference to FIG. 1 to FIG. 8. FIG. 1 is an overview of a GPS system including an electronic timepiece according to the invention. The outline of a GPS system whereby an electronic timepiece acquires positioning information and time information for the current location using satellite signals as external signals acquired from an external source (satellite) is described first below.

The electronic timepiece 10 in this example is a wristwatch that corrects the internal time by receiving signals (satellite signals) from GPS satellites 8, and displays the time on the opposite side (below called the face) as the side (below called the back) that is worn in contact with the skin. The GPS satellites 8 are navigation satellites orbiting the Earth on known orbits in space, and transmit a navigation message superimposed on a 1.57542 GHz carrier (L1 signal). Herein, the 1.57542 GHz signal on which the navigation message is superimposed is referred to as a satellite signal. The satellite signals are right-hand circularly polarized waves.

At present, there are approximately 30 GPS satellites 8 in orbit (only four shown in FIG. 1). To enable identifying which GPS satellite 8 transmitted a specific satellite signal, each GPS satellite 8 superimposes a unique 1023 chip (1 ms period) pattern called a C/A code (Coarse/Acquisition Code) on the satellite signals transmitted by that satellite. Each chip in the C/A code is a value of either +1 or −1 in a pseudorandom pattern. The C/A code superimposed on a particular satellite signal can therefore be detected by determining the correlation between the satellite signal and the pattern of each C/A code.

Each GPS satellite 8 carries anatomic clock, and each satellite signal carries GPS time information that is kept by the atomic clock. The electronic timepiece 10 receives the satellite signals transmitted from a single GPS satellite 8, and sets the internal time to the time (time information) acquired from the GPS time information carried in the received satellite signals.

Orbit information indicating the location of the GPS satellite 8 on its orbit is also included in the satellite signals. The electronic timepiece 10 can therefore also calculate its location (positioning information) using the GPS time information and orbit information. The positioning information calculation supposes that there is some degree of error in the internal time kept by the electronic timepiece 10. More specifically, in addition to the x, y, z parameters required to identify the location of the electronic timepiece 10 in three-dimensional space, the time error of the internal clock of the electronic timepiece 10 is also unknown. The electronic timepiece 10 therefore generally receives satellite signals transmitted from four or more GPS satellites 8, calculates the position based on the GPS time information and orbit information contained in the satellite signals, and thereby acquires positioning information identifying the current location.

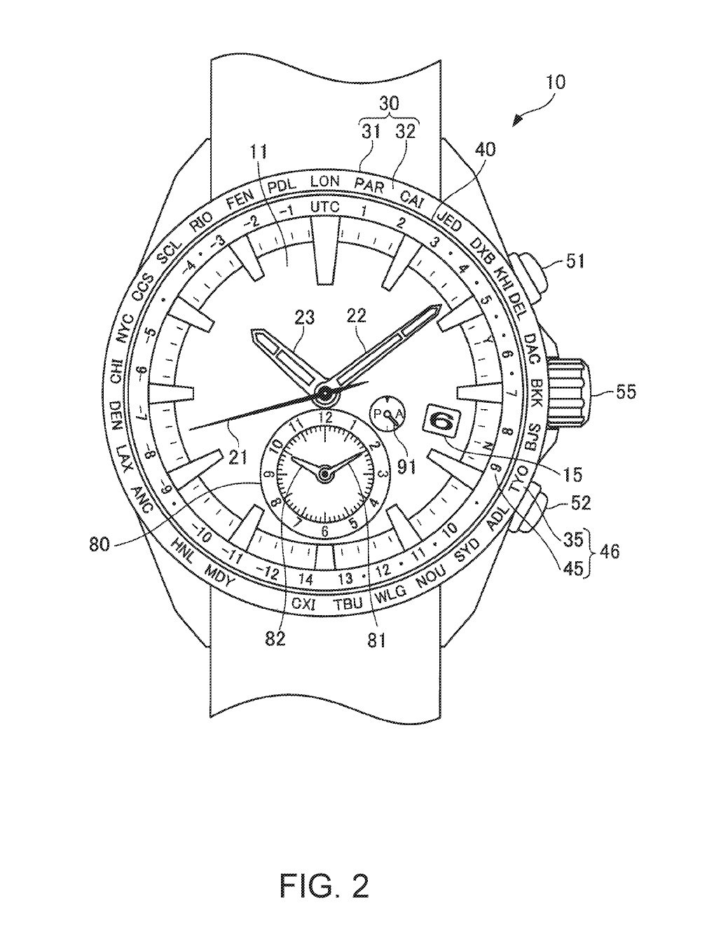

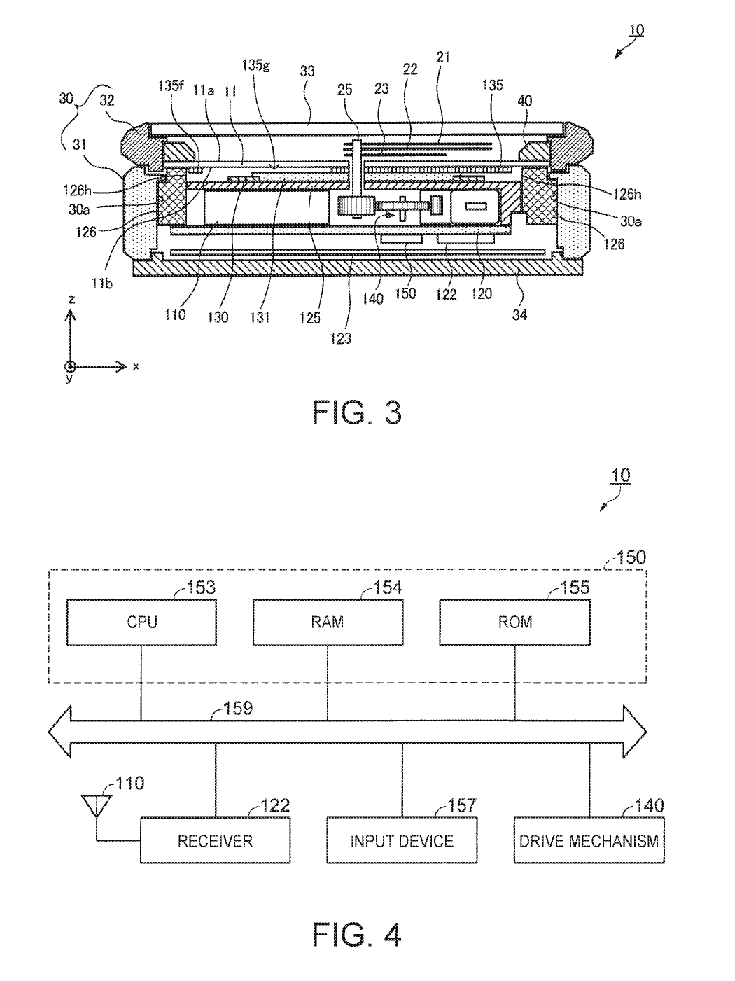

The general configuration of the electronic timepiece 10 is described next. FIG. 2 is a plan view of the electronic timepiece 10 from the face side, and FIG. 3 is a section view illustrating the general configuration of the electronic timepiece 10.

The electronic timepiece 10 has an outside case 30, crystal 33, and back cover 34. The outside case 30 includes a tubular metal case member 31, and a ceramic bezel 32 that is fit to the case member 31. On the inside circumference side of the bezel 32 are a dial ring 40, which is a ring made of resin, and a round dial 11 for displaying the time.

In the side of the outside case 30 offset from the center of the dial 11 are a button A 51 at 2:00, a button B 52 at 4:00, and a crown 55 at 3:00.

Of the two large openings in the outside case 30, the opening on the face side is covered by the crystal 33 held in place by the bezel 32, and the opening on the back cover side is covered by a metal back cover 34.

Also disposed (housed) inside the outside case 30 are the dial ring 40 affixed to the inside circumference of the bezel 32; the optically transparent dial 11; a center pivot 25 passing through the dial 11; hands 21, 22, 23 that rotate on the center pivot 25; a solar battery 135; antenna 110; dial bridge ring 126; main plate 125; date indicator 130; date indicator bridge 131; and drive mechanism 140 that drives the hands 21, 22, 23.

The center pivot 25 passes through the plane center of the outside case 30, and is aligned on the center axis through the face and back cover.

The dial ring 40 is disposed with its outside edge touching the inside circumference of the bezel 32, has a flat surface parallel to the crystal 33, and a beveled portion sloping to the dial 11 with the inside circumference edge touching the dial 11. The dial ring 40 is shaped like a ring in plan view, and is conically shaped when seen in section.

The dial 11 is a round disk for displaying the time inside the outside case 30, is made from plastic or other optically transparent material, and is disposed below the dial ring 40 with the hands 21, 22, 23 between the dial 11 and crystal 33.

The dial 11 has a first side 11a to which external light is incident, and an other side 11b that emits the external light.

The view of the parts of the electronic timepiece 10 from the direction perpendicular to the dial 11 (the direction parallel to the axis of the center pivot 25) is referred to as the plan view. The direction perpendicular to the dial 11 is also referred to as the thickness direction.

The view of the parts of the electronic timepiece 10 when seen in section from the direction parallel to the face of the dial 11 is referred to as the view in cross section.

The side on the back cover 34 side of the dial 11 is referred to as below or the back cover side in the thickness direction, and the side on dial 11 side of the back cover 34 is referred to as above or the face side in the thickness direction. An XYZ coordinate system, with the Z-axis being the thickness direction (with +Z being to the top or face), is shown in FIG. 3.

The solar battery 135 (photovoltaic cell) is disposed on the side of the dial 11 to which the external light is emitted (that is, below the dial 11). The solar battery 135 is disposed between the dial 11 and main plate 125. The solar battery 135 comprises solar cells (photovoltaic devices) that convert light energy to electrical energy (power) when light emitted from (passing through) the dial 11 is incident thereto. The solar battery 135 also has a sunlight detection capability.

The antenna 110 for receiving radio signals is disposed on the side of the dial 11 in the direction to which external light is emitted (that is, below the dial 11). The antenna 110 is disposed below the solar battery 135. The antenna 110 in this example is a patch antenna (also called a microstrip antenna).

As described in detail below, if the solar cells of the solar battery 135 are superimposed in plan view with the antenna 110, the radio signals the antenna 110 should receive will be shielded. To suppress such shielding, a through-hole 135g is provided in the solar battery 135 as an area where a solar cell is not disposed. The antenna 110 is disposed below the through-hole 135g so as to be superimposed with the through-hole 135g in plan view. The solar battery 135 also has a flange member 135f on the outside circumference side of the through-hole 135g (on the outside case 30 side in plan view).

A dial bridge ring 126 that supports the dial 11 is disposed in the direction in which external light is emitted from the dial 11 (that is, below the dial 11). The dial bridge ring 126 is made of plastic. The dial bridge ring 126 is also shaped like a ring along the inside circumference surface 30a of the outside case 30. The solar battery 135 is disposed, in plan view, on the inside side of the inside circumference surface 126h of the dial bridge ring 126.

Disposed to the main plate 125 are the date indicator 130 and the date indicator bridge 131 that supports the date indicator 130. The date indicator 130 and date indicator bridge 131 are plastic. The date indicator 130 and date indicator bridge 131 are disposed between the solar battery 135 and the main plate 125.

Through-holes through which the center pivot 25 and the pivots of the small hands 81, 82 of the small dial 80 pass are formed in the dial 11, solar battery 135, date indicator bridge 131, and main plate 125. An opening for a calendar window 15 is also formed in the dial 11 and solar battery 135.

The main plate 125 is made of plastic, and has attachments for the drive mechanism 140. The drive mechanism 140 is affixed to the main plate 125, and is covered from the back cover side by a circuit board 120. The drive mechanism 140 includes a stepper motor and a wheel train of wheels, and the hands 21, 22, 23 are driven by the stepper motor turning the center pivot 25 through the wheel train. The small hands 81, 82 of the small dial 80 have a similar drive mechanism (not shown in the figure) that drives the small hands 81, 82.

Disposed to the circuit board 120 are a receiver (GPS module) 122, controller 150, and antenna 110. The circuit board 120 is also connected to a lithium ion battery or other type of storage battery (not shown in the figure) that is charged by power produced by the solar battery 135. Below the circuit board 120 is a circuit cover 123.

B: Display Functions of the Electronic Timepiece

As shown in FIG. 2, a scale dividing the inside circumference into 60 parts is disposed to the inside circumference side of the dial ring 40 around the outside circumference of the dial 11. Using this scale, hand 21 (referred to below as the second hand 21) normally indicates the second of a first time, hand 22 (referred to below as the minute hand 22) normally indicates the minute of the first time, and hand 23 (referred to below as the hour hand 23) normally indicates the hour of the first time. The second of the first time is the same as the second of a second time, and the user can therefore know the second of the second time by reading the second hand 21.

The dial ring 40 also has the letter Y at the 12 minute marker, and the letter N at the 18 minute marker. These letters are used to indicate whether or not receiving (acquiring) required information based on the satellite signals received from the GPS satellite 8 was successful (Y indicating Yes, reception (information acquisition) was successful; and N indicating No, reception failed). The second hand 21 points to Y or N to indicate the result of satellite signal reception. The result of reception is displayed in response to the user pushing the button A 51 for less than 3 seconds.

The small dial 80 and small hands 81, 82 are disposed offset from the center of the dial 11 to the 6:00 position. Hand 81 (referred to below as the small minute hand) indicates the minute of a second time, and hand 82 (referred to below as the small hour hand) indicates the hour of the second time.

Another hand 91 is disposed to a position offset toward 4:00 from the center of the dial 11, and indicates whether the second time is ante meridiem or post meridiem.

The calendar window 15 is disposed in a rectangular opening in the dial 11, enabling a number to be seen through the opening. The number in this example indicates the date of the current year, month, date values.

Time difference information 45 for indicating the time difference to UTC (Coordinated Universal Time) is displayed on a scale along the inside circumference of the dial ring 40 using numeric and non-numeric markers. Numeric time difference information 45 indicates the integer number of hours of the time difference, and the non-numeric markers indicate a time difference less than one hour. The time difference between UTC and the first time indicated by the hands 21, 22, 23 can be checked by reading the time difference information 45 indicated by the second hand 21 when the button B 52 is pushed.

On the bezel 32 disposed around the dial ring 40 are disposed city information markers 35 beside the corresponding time difference information 45. The city information markers 35 indicate the name of a city representative of the time zone using the standard time corresponding to the time difference indicated by the time difference information 45 shown on the dial ring 40. The time difference information 45 and city information markers 35 are referred to as time zone indicators 46. The electronic timepiece in this example has the same number of time zone indicators 46 as there are time zones around the world. The city name markers shown in FIG. 2 are also only examples, and the city names may be changed as appropriate to changes in time zones.

C: Electrical Configuration of the Electronic Timepiece

The electrical configuration of the electronic timepiece 10 is described next.

FIG. 4 is a block diagram of the electrical control system of the electronic timepiece. As shown in FIG. 4, the electronic timepiece 10 has a controller 150 including a CPU (Central Processing Unit) 153, RAM (Random Access Memory) 154, ROM (Read Only Memory) 155, and peripheral devices including a receiver (GPS module) 122, input device 157, and drive mechanism 140. These devices exchange data therebetween through a data bus 159. The input device 157 includes the button A 51, button B 52, and crown 55 shown in FIG. 2. Note that the electronic timepiece 10 also has an internal rechargeable storage battery (not shown in the figure) as the power supply.

The receiver 122 includes the antenna 110, processes satellite signals received through the antenna 110, and acquires GPS time information and positioning information. The antenna 110 receives the radio waves of the satellite signals transmitted from multiple GPS satellites 8, which are orbiting the Earth on known orbits in space (see FIG. 1), and passing through the crystal 33 shown in FIG. 3.

While not shown in the figure, the receiver 122, similarly to a conventional GPS receiver, also includes an RF (radio frequency) unit for receiving and converting to digital signals the satellite signals transmitted from the GPS satellites 8 (see FIG. 1); a baseband unit for applying a correlation process to the received signals and demodulating the navigation message; and an information acquisition unit for acquiring and outputting the GPS time information and positioning information (location information) from the navigation message (satellite signals) demodulated by the baseband unit. In other words, the receiver 122 functions as a reception module that receives satellite signals transmitted from the GPS satellites 8, and based on the received signals outputs GPS time information and positioning information.

The RF unit includes a bandpass filter, PLL circuit, IF filter, VCO (Voltage Controlled Oscillator), ADC (Analog/Digital Converter), mixer, LNA (Low Noise Amplifier), and IF amplifier. The satellite signals are extracted by the bandpass filter, then amplified by the LNA, mixed by the mixer with the VCO signal, and then down-converted to an IF (Intermediate Frequency) signal. The IF signal mixed by the mixer passes through the IF amplifier and IF filter, and is converted to a digital signal by the ADC.

The baseband unit also has a local code generator that generates a local code of the same C/A codes used by the transmitting GPS satellites 8, and a correlator that calculates the correlation between the local code and the received signal output from the RF unit. If the correlation calculated by the correlator equals or exceeds a specific threshold, the C/A code used in the received satellite signal is determined to match the local code that was generated, and the receiver 122 can lock onto (synchronize) the satellite signal. The navigation message can be demodulated by this process of correlating the received satellite signal with a local code.

The information acquisition unit acquires the GPS time information and positioning information from the navigation message demodulated by the baseband unit. The navigation message includes preamble data, a HOW word with TOW (Time of Week, also referred to as the Z count) information, and subframe data. The subframe data includes subframe 1 to subframe 5, and each subframe carries satellite correction data including week number data and satellite health data, and orbit information including ephemeris (detailed orbit information for a particular GPS satellite 8) and an almanac (coarse orbit information about all GPS satellites 8). The information acquisition unit can therefore acquire the GPS time information and positioning information by extracting specific data portions from the received navigation message.

The RAM 154 and ROM 155 embody the memory of the electronic timepiece 10.

A program executed by the CPU 153, and other information such as time zone information, is stored in ROM 155. The time zone information is data for managing positioning information (latitude and longitude) about the region (time zone) using a common standard time, and the time difference of that region to UTC.

The CPU 153, by running the program stored in ROM 155 using RAM 154 as working memory, performs various calculations, control, and timekeeping processes. In this example, time is kept by counting the number of pulses in a reference signal output from a crystal oscillator not shown.

The CPU 153 corrects the time kept internally (the internal time) based on time information calculated from the GPS time information and time correction parameter, the positioning information (latitude and longitude) for the current location calculated from the GPS time information and orbit information, and time zone information stored in ROM 155 (memory). The CPU 153 also controls driving the drive mechanism 140 to display the internal time. As a result, the internal time is displayed on the electronic timepiece 10.

D: Solar Battery Configuration

The solar battery 135 used in this electronic timepiece 10 is described in detail below. The dial bridge ring 126 and main plate 125 are also described.

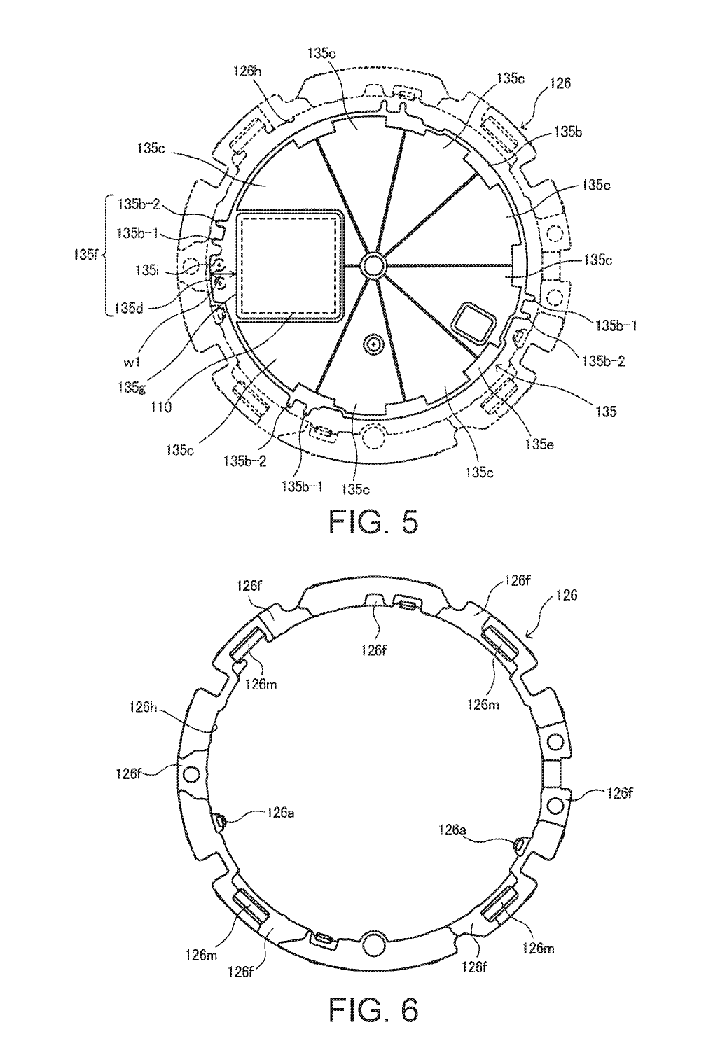

The arrangement of the solar battery 135 and antenna 110 in plan view is described below. FIG. 5 is a plan view of the solar battery 135. The contour of the antenna 110 is shown in FIG. 5. The antenna 110, which has a flat rectangular shape, is disposed to the 9:00 position in this example.

The solar battery 135 has a solar film 135b. In addition to the solar film 135b, the solar battery 135 may have a guide plate to which are disposed positioning parts for attaching the solar battery 135 to other members (such as the main plate 125 or the dial bridge ring 126).

The solar film 135b includes a substrate 135e and solar cells 135c. The substrate 135e is made from a plastic film, for example, and the solar cells 135c are formed on the substrate 135e. The solar cells 135c have a semiconductor part and an electrode part. The semiconductor part converts light energy to electrical energy by photovoltaic conversion. The electrode part has electrodes on opposite sides of the semiconductor part. An optically transparent electrode may be used as the electrode on the side to which light is incident.

The outside of the solar battery 135 a substantially a circle. The multiple (in this example, eight) solar cells 135c are arrayed along the circumference of the circle and are connected in series. If the electrode part of the solar cells 135c is superimposed in plan view with the antenna 110, the radio waves of the satellite signals the antenna 110 should receive will be shielded.

The solar battery 135 has a rectangular through-hole 135g at the 9:00 position. The substrate 135e and solar cells 135c are not disposed in the through-hole 135g. By disposing the antenna 110 superimposed with the through-hole 135g in plan view, the antenna 110 has a part that is not superimposed with the solar battery 135 (not superimposed with at least the solar cells 135c). Shielding of radio waves due to the antenna 110 being superimposed with the solar cells 135c can therefore be suppressed.

Note that all parts of the antenna 110 preferably have no part superimposed in plan view with the solar cells 135c, but even if part of the antenna 110 is superimposed with the solar cells 135c, the shielding described above can still be suppressed compared with when all parts of the antenna 110 are superimposed with the solar cells 135c.

The through-hole 135g is provided in this embodiment of the invention as a part (referred to below as the solar battery-free part) where the solar cells 135c of the solar battery 135 are not disposed above the antenna 110. Suppose a first comparison sample configured as described below. The first comparison sample has a notch formed in the outside circumference part of the solar battery 135 as the solar battery-free part.

When a notch such as in the first comparison sample is provided, the outside shape of the solar battery 135 is formed with a notch therein, and is roughly C-shaped. The parts on opposite sides of the notch in the solar battery 135 come to a point at the outside circumference (distal) ends, and are easily deformed or bent. Because the outside circumference part of the solar battery 135 is easily deformed with a notch is provided as described above, the solar battery 135 is difficult to handle when assembling the electronic timepiece 10. Furthermore, if the parts on the opposite sides of the notch in the solar battery 135 are bent in the assembled electronic timepiece 10, the solar battery-free part is easily recognized because the bent parts can be seen through the transparent dial 11.

By providing a through-hole 135g as the solar battery-free part, this embodiment of the invention can keep the outside shape of the solar battery 135 substantially round. As a result, compared with the first comparison sample having a notch as described above, the outside shape of the solar battery 135 is not easily deformed, and the solar battery 135 is easier to handle when assembling the electronic timepiece 10. The solar battery-free part of the solar battery 135 is also difficult to see in the assembled electronic timepiece 10.

A flange member 135f (the flange member 135f protruding toward the outside case 30 in plan view) protruding to the outside is also disposed to the solar battery 135. The flange member 135f is disposed on the outside circumference side of the through-hole 135g (so that the through-hole 135g is positioned to the inside of the outside case 30 from the flange member 135f in plan view (that is, so that the flange member 135f is between the inside circumference surface of the outside case 30 and the through-hole 135g)).

The contour of the dial bridge ring 126 is also shown in FIG. 5. In plan view, the solar battery 135 is disposed on the inside side of the inside circumference surface 126h of the dial bridge ring 126, separated from the inside circumference surface 126h. The flange member 135f is disposed using the gap between the inside circumference of the dial bridge ring 126 and the outside circumference of the solar battery 135.

A second comparison sample is considered next. The second comparison sample has a through-hole 135g without having a flange member 135f on the solar battery 135. By forming a flange member 135f and disposing the through-hole 135g inside of the outside case 30 from the flange member 135f as in the foregoing embodiment of the invention, the width w1 from the outside circumference edge of the solar battery 135 to the edge of the through-hole can be increased when compared with a configuration having a through-hole 135g without having a flange member 135f as in the second comparison sample. By increasing width w1, the strength of the solar battery 135 in the part on the outside circumference side of the through-hole 135g can be increased.

In the example shown in FIG. 5, the flange member 135f disposed on the outside circumference side of the through-hole 135g has guide tabs 135b-1 and guide tabs 135b-2, and a conductor 135d. The guide tabs 135b-1 and guide tabs 135b-2, and conductor 135d, are disposed to the outside circumference part of the substrate 135e of the solar battery 135.

The guide tabs 135b-1 and guide tabs 135b-2 are used as positioning parts for positioning the solar battery 135 on the main plate 125 (first member). The flange member 135f can thus also be used as a positioning member.

The conductor 135d has a connection terminal 135i connected to a wiring member electrically connecting the solar battery 135 to the circuit board 120. In this way, the flange member 135f can also be used as a connector to the wiring member. The wiring member in this example is a conductive spring.

The dial bridge ring 126 is described next. FIG. 6 is a plan view illustrating the configuration of the dial bridge ring 126. The dial bridge ring 126 has solar battery hooks 126a, main plate bridge parts 126f, and protrusions 126m.

The solar battery hooks 126a are used to hold the solar battery 135 to the dial bridge ring 126. An engaging member (not shown in the figure) disposed to the solar battery 135 described above engages with the solar battery hooks 126a. The main plate bridge parts 126f are disposed to positions corresponding to the flanges 125f of the main plate 125 described below, and are fit together with the flanges 125f. The protrusions 126m protrude from the bottom of the dial bridge ring 126 to the back cover 34 side, contact the back cover 34 when the dial bridge ring 126 is placed in the outside case 30, and thereby restrict movement of the dial bridge ring 126 in the thickness direction.

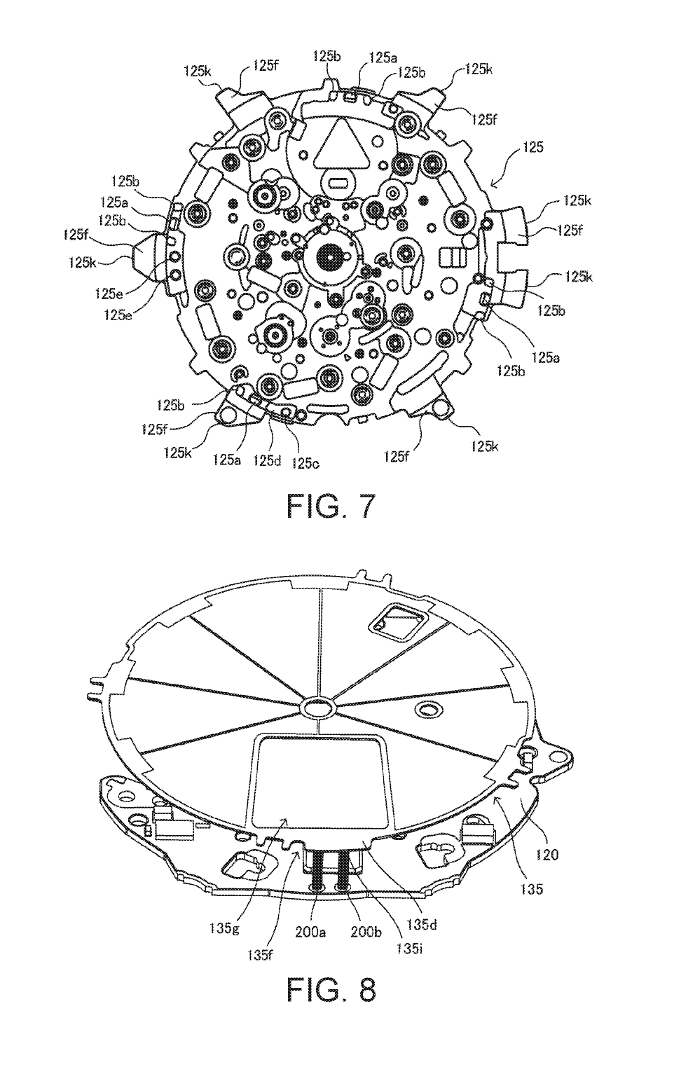

The main plate 125 is described next. FIG. 7 is a plan view illustrating the configuration of the main plate 125. Disposed to the main plate 125 are guide protrusions 125a, dial height positioning pedestals 125b, fastening pin 125c, and a flange 125d to which the fastening pin 125c is disposed.

The solar battery 135 is positioned to the main plate 125, and movement in the circumferential direction is restricted, by the guide tabs 135b-1 and guide tabs 135b-2 of the solar battery 135 being set with the guide protrusions 125a therebetween. The dial height positioning pedestals 125b and flange 125d embody a dial mounting surface on which the dial 11 rests. The fastening pin 125c fits into a hole in the dial ring 40, and secures the dial ring 40.

Also disposed to the main plate 125 are through-holes 125e, flanges 125f, and tabs 125k disposed to the distal ends of the flanges 125f. A conductive spring for electrically connecting the solar battery 135 and the circuit board 120 is disposed in the through-holes 125e. The main plate 125 and dial bridge ring 126 are mutually engaged by the flanges 125f being fit to the main plate bridge parts 126f of the dial bridge ring 126. The tabs 125k restrict movement of the main plate 125 in the plane direction by contacting the inside circumference side of the case member 31 when the main plate 125 is set in the outside case 30.

The electrical connection between the solar battery 135 and circuit board 120 is described next.

FIG. 8 is an oblique view illustrating the main plate 125 and circuit board 120 when connected. One end of conductive springs 200a and 200b is connected to the conductor 135d in the flange member 135f of the solar battery 135, and the other end of the conductive springs 200a and 200b is connected to the circuit board 120.

The invention is not limited to the foregoing embodiment, and can be varied in many ways such as described in the following variations. One or all of the variations and embodiments described below can also be selectively combined in various ways.

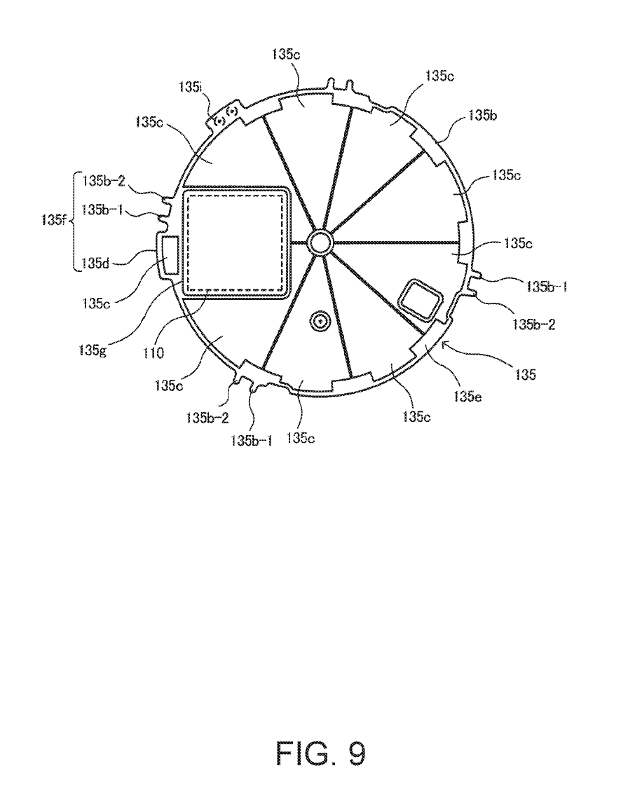

FIG. 9 is a plan view illustrating the configuration of the solar battery 135 in a variation of the foregoing embodiment. The foregoing embodiment describes an example in which a solar cell 135c is not disposed to the flange member 135f disposed on the outside circumference side of the through-hole 135g, but a solar cell 135c may be disposed to the flange member 135f as described in this variation. By disposing a solar cell 135c to the flange member 135f, power generating capacity can be increased. This configuration is particularly useful in electronic timepieces having a large face. In this example, the solar cell 135c is disposed to the part 135d used as a conductor in the embodiment described above. However, in this example, this part 135d is not used as a conductor. Instead, a connection terminal 135i is disposed as a conductor at a separate location along the circumference of the solar battery 135.

The foregoing embodiment and variations describe a configuration in which the flange member 135f is a part with multiple functions (a positioning member, connector to a wiring member, location for a solar cell 135c), but the flange member 135f may be provided as a part with no additional function.

Note that the length of the flange member 135f along the circumference may be greater than the size of the through-hole 135g along the circumference. In this configuration, the through-hole 135g may be disposed protruding to the outside circumference side (outside case 30 side) from the outside edge of the round part of the solar battery 135. Even when the through-hole 135g is thus formed, the flange member 135f protrudes to the outside from the through-hole 135g, and in plan view the through-hole 135g is to the inside of the outside case 30 from the flange member 135f.

The invention being thus described, it will be obvious that it may be varied in many ways. Such variations are not to be regarded as a departure from the spirit and scope of the invention, and all such modifications as would be obvious to one skilled in the art are intended to be included within the scope of the following claims.

The entire disclosure of Japanese Patent Application No. 2017-054377, filed Mar. 21, 2017 is expressly incorporated by reference herein.

What is claimed is:

1. An electronic timepiece comprising:
an optically transparent dial having one surface to which external light is incident, and another surface from which the external light is emitted;
a solar battery disposed relative to the dial in the direction in which the external light is emitted, and having a photovoltaic solar cell;
an antenna disposed relative to the dial in the direction in which the external light is emitted, and receiving radio signals; and
an outside case configured to house the dial, the solar battery, and the antenna;
a through-hole being disposed in the solar battery;
the antenna having an overlap with the through-hole when seen in plan view from a direction perpendicular to the dial;
the solar battery having a flange protruding to the outside case side in plan view; and
the flange disposed so that in plan view the through-hole is located on the inside side of the outside case from the flange.

2. The electronic timepiece described in claim 1, further comprising:
a first member disposed positioned with the solar battery;
the flange having a positioning part configured to position the solar battery to the first member.

3. The electronic timepiece described in claim 1, further comprising:
a circuit board connected to the solar battery;
the flange having a connection terminal connected to a wiring member that connects the solar battery to the circuit board.

4. The electronic timepiece described in claim 1, further comprising a solar cell disposed to the flange.
